(19) United States
(12) Patent Application Publication
(10) Pub. No.: US 2010/0013301 A1
(43) Pub. Date: Jan. 21, 2010

(54) ELECTRIC POWER SUPPLY SYSTEM

(75) Inventors: Kenichi Hamada, Kanagawa-ken (JP); Nobuyuki Kitamura, Yamanashi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, TOYOTA-SHI (JP)

(21) Appl. No.: 12/514,736

(22) PCT Filed: Nov. 12, 2007
(86) PCT No.: PCT/JP2007/072331

§ 371 Date: Jul. 8, 2009

(30) Foreign Application Priority Data
Nov. 13, 2006 (JP) 2006-306887

(51) Int. Cl. B60L 11/00; H02J 3/38

(52) U.S. Cl. 307/10.1; 307/82; 903/903

(57) ABSTRACT

An electric power supply system mounted on a moving body, which supplies electric power from a plurality of direct-current power source devices to an alternating-current drive apparatus that functions as a drive source of the moving body. Each of the plurality of direct-current power source devices is connected to a corresponding inverter, which converts a direct-current output of the direct-current power source device into an alternating-current output, thereby forming one alternating-current output unit. Alternating-current wirings are used to make connection between each alternating-current output unit and the alternating-current drive apparatus and between respective alternating-current output units. Thereby, it is possible to keep electrical insulation between electric power supply wirings and a moving body with relative ease and also make connection between the direct-current power source devices in a simple and easy way.

### TECHNICAL FIELD OF THE INVENTION

The present invention relates to an electric power supply system for supplying electric power to a drive apparatus, and for instance, to a system for supplying electric power from a fuel cell, which generates electric power through electrochemical reaction, to a drive apparatus.

### BACKGROUND ART

Recently, fuel cells have become focus of attention as power sources having excellent operating efficiencies and environmental properties. Although a fuel cell controls amount of fuel gas to be supplied and outputs electric power in response to request, the output of electric power may sometimes have low responsiveness due to response delay of the amount of gas to be supplied. Accordingly, a combined use of a battery and a fuel cell has been proposed, where the fuel cell and the battery (storage battery device) are connected in parallel to configure a power source and an output voltage of the fuel cell is converted via a DC-DC converter. Direct-current powers supplied from both the fuel cell and the battery are converted into alternating-current power by an inverter provided along with a drive apparatus and then is supplied to the drive apparatus (see Japanese Patent Application Laid-Open No. 2006-141097, for example).

In cases where the battery and the fuel cell as direct-current power source devices are provided in parallel to supply electric power to a motor as a alternating-current drive apparatus, as above, a technique has been disclosed that provides two inverters for the respective power source devices proximate to the motor and controls these inverters such that the battery and the fuel cell have the same neutral point electric potential (see Japanese Patent Application Laid-Open No. 2000-125411, for example). In this way, it is possible to avoid improper generation of current in the motor at the time electric power is supplied from the two power source devices.

In addition to the above-mentioned documents, Japanese Patent Application Laid-Open No. 2002-118981, Japanese Patent Application Laid-Open No. 2005-269801, Japanese Patent Application Laid-Open No. 2005-333783, and Japanese Patent Application Laid-Open No. 2006-60912 also disclose techniques relating to electric power supply systems.

### SUMMARY OF THE INVENTION

In cases where a moving body is driven by a drive apparatus by using a direct-current output from a direct-current power source device such as a fuel cell, a battery, and the like, the energy for driving is communicated to the drive apparatus in the form of electric energy. This allows more flexible configuration of electric power supply to be achieved in the moving body than in cases where mechanical energy is communicated to drive the moving body.

However, in order to supply electric power from a direct-current power source device such as a fuel cell, a battery, and the like to an alternating-current drive apparatus, an inverter for converting a direct-current output into an alternating-current output will be necessary. Since direct-current power of high voltage will be supplied through the section between the direct-current power source device and the inverter, it is required to, for security reasons, keep electrical insulation in that section, that is, keep high electrical insulation between electric power supply wirings and a moving body.

In addition, in case where direct-current power source devices of different output characteristics are connected together for use, a control device, for example a direct-current chopper converter, is employed to control the output characteristics of the both devices. However, this prevents downsizing of an electric power supply system for a drive apparatus by just that much of an element(s) comprising the control device (in case of the direct-current chopper converter, by just that much of a reactor comprising the same).

The present invention is made in view of the aforementioned problems, and is purposed to provide an electric power supply system for an alternating-current drive apparatus where, in cases where electric power is supplied from a plurality of direct-current power source devices to the alternating-current drive apparatus, it is possible keep electrical insulation between electric power supply wirings and a moving body with relative ease and also make connection between the direct-current power source devices in a simple and easy way.

In the present invention, in order to resolve the aforementioned problems, each direct-current power source device and an inverter corresponding thereto are made into one unit and alternating-current wirings are employed between units and between each unit and an alternating-current drive apparatus, in the course of configuring an electric power supply system for the alternating-current drive apparatus. That is, by configuring every external output from the unit to be an alternating-current output, it is possible to keep electrical insulation between the electric power supply wirings and a moving body with ease as well as make connection between the respective direct-current power source devices in a simple and easy way.

More specifically, the present invention relates to an electric power supply system mounted on a moving body, the electric power supply system supplying electric power from a plurality of direct-current power source devices to an alternating-current drive apparatus that functions as a drive source of the moving body, wherein:

each of the plurality of direct-current power source devices is connected to a corresponding inverter that converts a direct-current output of the direct-current power source device into an alternating-current output, and the each of the direct-current power source devices and the corresponding inverter corresponding thereto form one alternating-current output unit, and

an output of the alternating-current output unit to the outside of the unit is an alternating-current output, and alternating-current wirings are used to make connection between each alternating-current output unit and the alternating-current drive apparatus and between respective alternating-current output units.

As mentioned above, the electric power supply system according to the present invention is mounted on the moving body, and supplies electric power to the alternating-current drive apparatus that works to move the moving body. Note that the moving body according to the present invention is not limited to transportation means for people and freight, such as automobiles, trains, ships and the like, but covers overall objects that work for movement, such as robots and the like.

Although supply of electric power to the alternating-current drive apparatus of this moving body is conducted from the plurality of direct-current power source devices, the electric power supply system according to the present invention is characterized in that each of the direct-current power source devices and the inverter corresponding thereto are paired up to form an alternating-current output unit. This alternating-current output unit is an unit for electric power supply where the direct-current power source device and the inverter are stored inside of the unit and any output to the outside of the unit is configured as an alternating-current output. That is, in the electric power supply system, it is only inside of this alternating-current output unit that any direct-current wiring may be used. In the electric power supply system according to the present invention, a plurality of such alternating-current output units are provided, and alternating-current wirings are used for connection between the respective units and between each unit and the alternating-current drive apparatus, so as to supply alternating-current power to the alternating-current drive apparatus.

Accordingly, in the electric power supply system according to the present invention, where the alternating-current drive apparatus and the alternating-current output units being arranged as appropriate in the moving body according to the shape, size, and the like of the moving body, not direct-current power but alternating-current power will be transmitted between the alternating-current drive apparatus and the alternating-current output units, i.e. a section that in some cases occupies a large area of the moving body. This contributes greatly to facilitation of ensuring electrical insulation between the electric power supply system and the moving body. In addition, since the alternate-current units are also interconnected via the alternate-current wirings, the need for any control device, such as a direct-current chopper converter as in conventional cases where direct-current wirings are used for interconnection, can be eliminated, and thus downsizing of the electric power supply system can be realized.

In the aforementioned electric power supply system, the electric power supply system may include an alternating-current output control means that controls frequency and/or amplitude of an alternating-current output from the alternating-current output unit according to a requested electric power from the alternating-current drive apparatus. This alternating-current output control means can control frequency and amplitude of an alternating-current output from each alternating-current output unit by controlling the inverter included in that unit. Here, note that, essentially, frequency and amplitude of an alternating-current output from each alternating-current output unit may be increased as a requested electric power from the alternating-current drive apparatus becomes higher. However, as the frequency of the alternating-current output becomes higher, skin effect may occur and result in increased surface heat generation in the alternating-current wirings. In addition, as the amplitude of the alternating-current output becomes larger, magnetic field may be generated and result in increased inductance loss in the alternating-current wirings. Therefore, it is preferable that the alternating-current output control means controls frequency and amplitude of an alternating-current output from the alternating-current output unit in consideration of the surface heat generation resulting from skin effect and the inductance loss resulting from magnetic field generation.

In the electric power supply system described hereinabove, if one of the plurality of direct-current power source device is a reference direct-current power source device, the electric power supply system may include an alternating-current phase control means that controls phase difference of an alternating-current output from one alternating-current output unit including the direct-current power source device other than the reference direct-current power source device with respect to an alternating-current output from the reference alternating-current output unit including the reference direct-current power source device.

This alternating-current phase control means can control phase of an alternating-current output from each alternating-current output unit by controlling the inverter that is included in that unit. Here, note that the alternating-current phase control means can increase the substantial supply electric power from the one alternating-current output unit to the alternating-current drive apparatus by advancing the phase of the alternating-current output from the one alternating-current output unit with respect to the phase of the alternating-current output from the reference alternating-current output unit. That is, by this advancing phase control, the electric power from the one alternating-current output unit can preferentially be supplied to the alternating-current drive apparatus. As such, by using the alternating-current control means to control the phase difference between the both alternating-current outputs, it is possible to control an amount of electric power to be actually supplied from the one alternating-current output unit to the alternating-current drive apparatus.

In the aforementioned electric power supply system, the alternating-current phase control means may make the alternating-current output from the reference alternating-current output unit and the alternating-current output from the one alternating-current output unit have the same phase, thereby setting output electric power from the one alternating-current output unit to zero. That is, by using the alternating-current phase difference control means to set the phase difference between the both alternating-current outputs to zero, output electric power from the one alternating-current output unit will be made zero, and thus, only output electric power from the reference alternating-current output unit will be supplied to the alternating-current drive apparatus. Therefore, in this case, it is possible to reduce electric power consumption related to the one alternating-current output unit.

The electric power supply system described hereinabove has two direct-current power source devices, where one direct-current power source device may be an electric power generating device that outputs direct-current power through generation of electric power, and/or the other direct-current power source device may be a storage battery device that has a storage means and outputs electric power stored by the storage means as direct-current power. The electric power generating device may be any type of electric power generating device as long as it can obtain direct-current output, including a fuel cell that generates electric power through electrochemical reaction between hydrogen gas and oxidizing gas and thereby outputs direct-current power, for example. Examples of the storage battery device include battery, capacitor, and the like.

In the electric power supply system described hereinabove, the electric power supply system may include a matrix converter that has an input of alternating-current output from each of the alternating-current output units and thereby outputs any alternating-current output with respect to the alternating-current drive apparatus. With the matrix converter, it is possible to adjust frequency and amplitude of the alternating-current power to the alternating-current drive apparatus in an arbitrary and efficient manner.

### BRIEF DESCRIPTION OF THE DRAWINGS

FIG. 1 is an illustration showing the schematic configuration of a vehicle on which an electric power supply system (fuel cell system) according to the present invention is mounted;

FIG. 2 is a first illustration showing the schematic configuration of an electric power system that is mounted on the vehicle shown in FIG. 1 and is configured to include the fuel cell system of the present invention;

FIG. 3 is an illustration showing the flow of electric power supply control for supplying electric power from an electric power supply section including a fuel cell to a drive motor, in the electric power system shown in FIG. 2;

FIG. 4A is a torque diagram for the drive motor of the vehicle shown in FIG. 1;

FIG. 4B is a diagram showing correlation between requested output from the drive motor of the vehicle shown in FIG. 1 and frequency of alternating-current supply power to be supplied from the fuel cell system to the drive motor; and

FIG. 4C is a diagram showing correlation between requested output from the drive motor of the vehicle shown in FIG. 1 and amplitude of alternating-current supply power to be supplied from the fuel cell system to the drive motor.

### BEST MODE FOR EMBODYING THE INVENTION

A mode for embodying an electric power supply system according to the present invention will now be described in detail based on the drawings. The electric power supply system according to the present mode is a fuel cell system that includes a fuel cell and supplies electric power to a drive motor as an alternating-current drive apparatus of an automobile as a moving body.

### First Embodiment

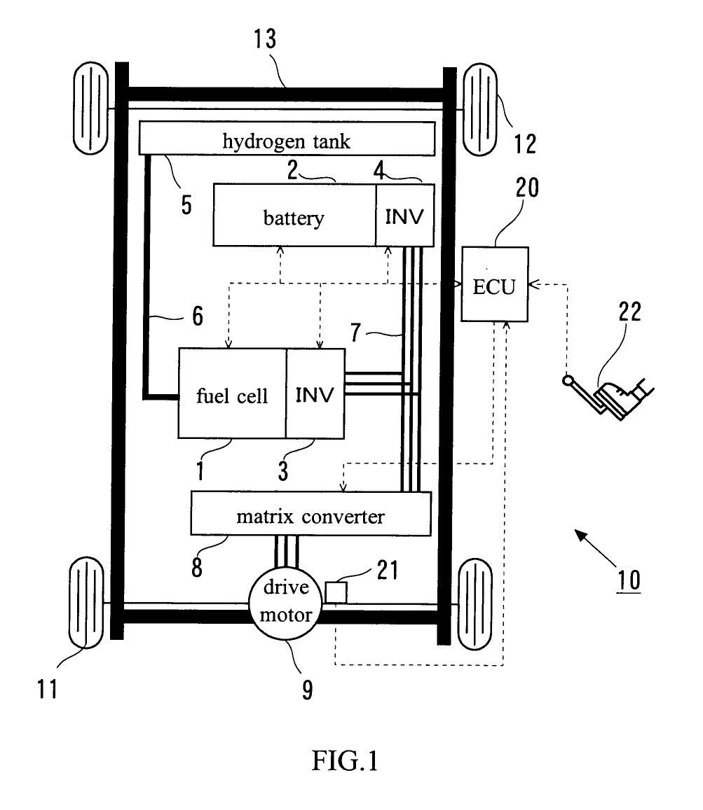

FIG. 1 is an illustration showing the schematic configuration of a vehicle 10 as a moving body, on which a fuel cell system as an electric power supply system according to the present invention is mounted and that employs supply of electric power from the system as a drive source. The vehicle 10 has front-side drive wheels 11 and rear-side drive wheels 12 attached to a vehicle body frame 13, and is allowed to move when the front drive wheels 11 is driven by a drive motor (hereinafter simply referred to as “motor”) 9 to run by themselves. The motor 9 is a so-called three phase alternating-current motor that receives supply of electric power from a fuel cell 1 and a battery 2, all of which being stably fixed on the vehicle body frame 13.

The fuel cell 1 receives supply of hydrogen gas as a fuel gas from a hydrogen tank 5 via a hydrogen supply route 6 as well as supply of air as an oxidizing gas from an air supply device not shown, and thereby generates electric power through electrochemical reaction therebetween. On the other hand, the battery 2 is a device that stores electric power generated by the fuel cell 1 and regenerative energy from the motor 9 as electric energy. The fuel cell 1 and the battery 2 are direct-current power source devices that output direct-current powers therefrom. In the fuel cell system according to the present invention, the fuel cell 1 and the battery 2 are respectively provided with inverters corresponding thereto, i.e. a fuel cell inverter 3 and a battery inverter 4. A direct-current output from the fuel cell 1 is converted into alternating-current power right away by the fuel cell inverter 3 and a direct-current output from the battery 2 is converted into alternating-current power right away by the battery inverter 4, and then supplied through alternating-current wiring routes 7 via a matrix converter 8 to the motor 9. Details of this electric power supply will be described later.

The vehicle 10 is further equipped with an electronic control unit (hereinafter referred to as “ECU”) 20. The fuel cell 1, the battery 2, and the inverters 3, 4 are electrically connected to the ECU 20, and thus have their respective operating conditions controlled by the ECU 20. The matrix converter 8 is also electrically connected to the ECU 20, and allows for control of number of revolutions per minute and output of the motor 9 at will. Furthermore, the vehicle 10 is also provided with an accelerator pedal 22 for receiving an acceleration request from an user, the degree of opening thereof being electrically communicated to the ECU 20. An encoder 21 for detecting a number of revolutions per minute of the motor 9 is also electrically connected to the ECU 20, and allows for detection of a number of revolutions per minute of the motor 9 at the ECU 20.

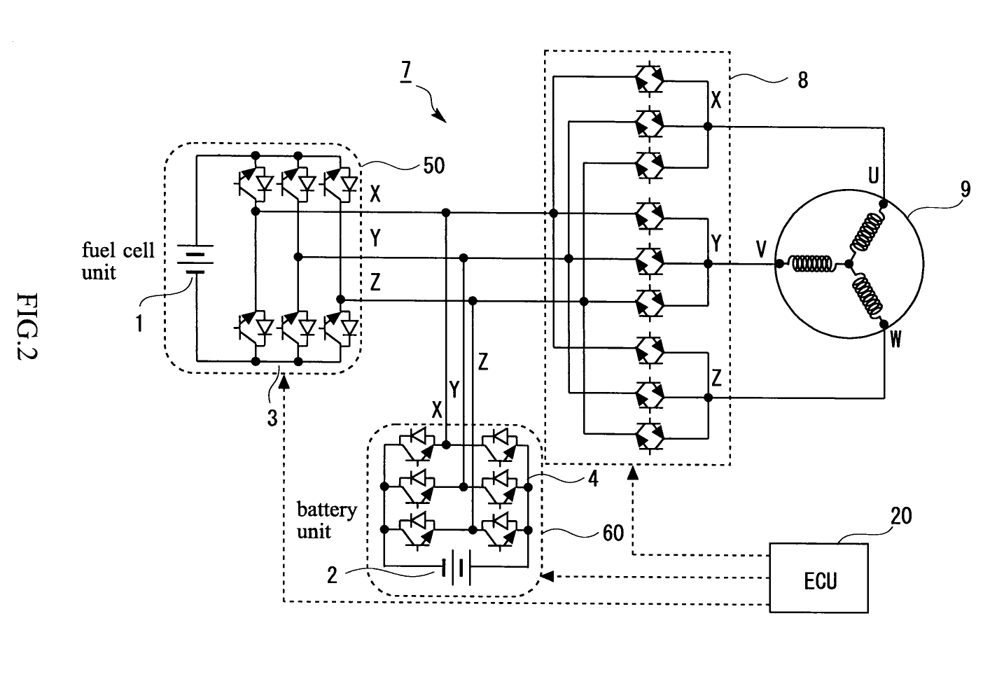

The electric power system of the fuel cell system of the vehicle 10 thus configured is now described in detail based on FIG. 2. FIG. 2 is a circuit diagram showing the schematic of the electric power system of the fuel cell system. In this fuel cell system, the fuel cell 1 and the fuel cell inverter 3 are contained within one housing to form a fuel cell unit 50. Therefore, direct-current power generated by the fuel cell 1 is converted into alternating-current power by the fuel cell inverter 3 right away. This results in the fuel cell unit 50 producing an alternating-current output of three phases X, Y, and Z. Note that in FIG. 1, this fuel cell unit 50 is shown to have the fuel cell 1 and the fuel cell inverter 3 adjoining to each other.

On the other hand, the battery 2 and the battery inverter 4 are also contained within one housing to form a battery unit 60 as well. Therefore, direct-current power electrically stored by the battery 2 is converted into alternating-current power by the battery inverter 4 right away once discharged. This results in the battery unit 60 producing an alternating-current output of three phases, X, Y, and Z. Note that in FIG. 1, this battery unit 60 is shown to have the battery 2 and the battery inverter 4 adjoining to each other.

The three phases X, Y, and Z of the fuel cell unit 50 and the battery unit 60 are respectively connected to each other at the alternating-current wiring routes 7, and then input to X, Y, and Z of the matrix converter 8. Since the alternating-current wiring routes 7 are for three phase alternating-current use, the matrix converter 8 is formed of nine bi-directional switches incorporated therein. Through operations of these bi-directional switches, it is possible to adjust, as appropriate, frequency and/or amplitude of an alternating-current output from the matrix converter 8, that is, of alternating-current power to be supplied to the motor 9. The three phases X, Y, and Z of the output from the matrix converter 8 are respectively connected to phases U, V, and W of the motor 9.

In the fuel cell system according to the present invention that is configured as hereinabove, direct-current powers output from the fuel cell 1 and the battery 2 are converted into alternating-current powers by their respective inverters 3, 4, right away and thus take the form of alternating-current powers by the time they are output from the fuel cell unit 50 and the battery unit 60 to the outside of the units, respectively. Accordingly, with the fuel cell 1 and the battery 2 as the direct-current power source devices being arranged at their appropriate locations according to the shape, size, interior design and the like of the vehicle 10, as shown in FIG. 1, alternating-current wirings are employed to make connection across the section from the units 50, 60 respectively including power sources therein to the motor 9 as the drive apparatus. As a result, it becomes more easy to keep electrical insulation between the alternating-current wirings and the body of the vehicle 10 than in cases where direct-current wirings are employed for the connection. Also, since the two direct-current power source devices, i.e. the fuel cell 1 and the battery 2, are connected to each other via their respective inverters and by means of the alternating-current wirings, the need for any large-sized connection control device such as a reactor can be eliminated, and thus downsizing of the fuel cell system can be realized.

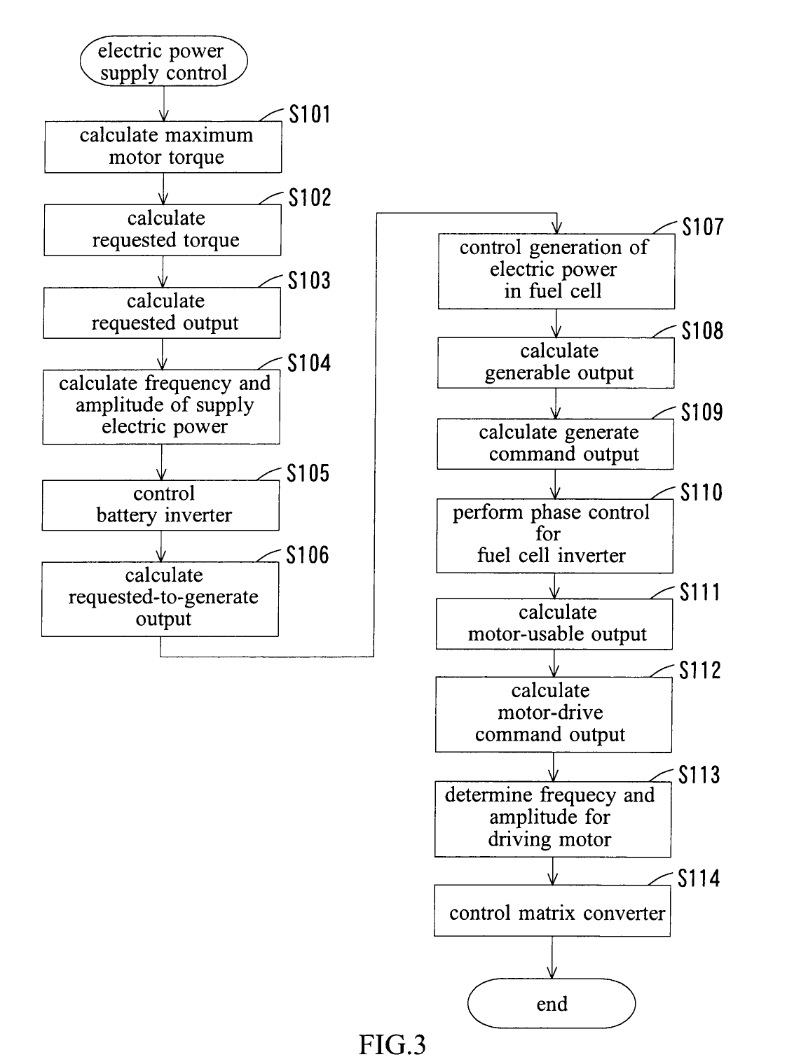

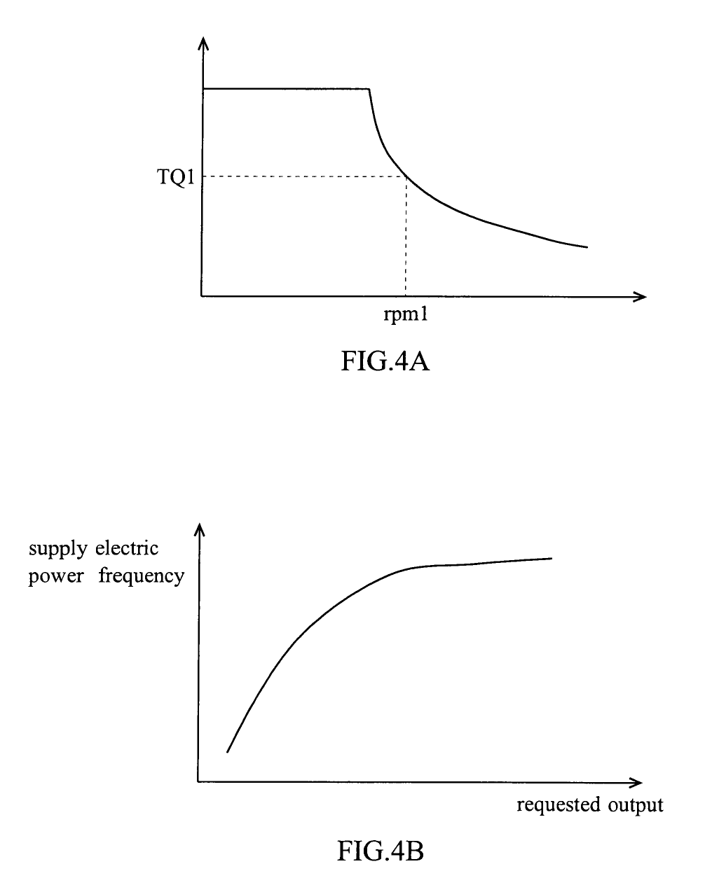

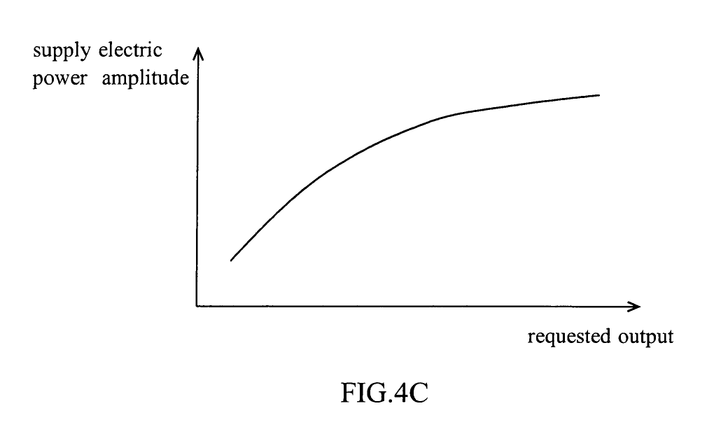

Now described based on FIG. 3 is electric power supply control in the electric power system of the vehicle 10 shown in FIG. 2. Note that the electric power supply control in the present embodiment is a routine executed by the ECU 20. First of all, in S101, a maximum torque that the motor 9 can output at a maximum is calculated, which corresponds an actual number of revolutions per minute of the motor 9 as detected by the encoder 21. Specifically, by having a maximum motor torque map that associates number of revolutions per minute of the motor 9 with maximum torque corresponding thereto, as shown in FIG. 4A, the ECU 20 compares the number of revolutions per minute of the motor 9 as detected by the encoder 21 to the map and thereby calculates the maximum torque of the motor 9 at that number of revolutions per minute. For example, as shown in FIG. 4A, if the motor has a number of revolutions per minute of rpm1, then the maximum motor torque is calculated to be TQ1. Once the operation of S101 is complete, the process proceeds to S102.

In S102, a requested torque that the motor 9 is requested for output is calculated based on a degree of opening of the accelerator pedal 22. Given that a full opened state of the accelerator pedal 22 requests the maximum torque of the motor 9 at the current number of revolutions per minute, and that a factor of 100% corresponds to the full opened state and a factor of 0% corresponds to a full closed state, then the requested torque is calculated according to the formula below. Once the operation of S102 is complete, the process proceeds to S103.

(requested torque)=(aforementioned maximum torque)*(coefficient according to degree of opening of accelerator pedal).

In S103, a requested output that the motor 9 is requested to output is calculated according to the formula below based on the results of calculations made in S101 and S102. Once the operation of S103 is complete, the process proceeds to S104.

(requested output)=(requested torque)*(number of revolutions of motor)

In S104, frequency and amplitude of supply electric power to be supplied to the motor 9 by the fuel cell system, that is, of an alternating-current output from each unit, are calculated, based on the requested output from the motor 9 calculated in S103. First of all, as for the frequency of supply electric power, the higher the frequency becomes, the higher requested output the supply electric power becomes able to conform to. However, as the frequency of supply electric power increases, skin effect may occur due to the high frequency and may result in surface heat generation more pronounced in the alternating-current wiring routes 7. Therefore, the calculation of the frequency of supply electric power will be made in accordance with a map of requested output−supply electric power frequency shown in FIG. 4B. In this map, correlation of requested output−supply electric power frequency is set such that the higher the requested output becomes, the smaller the increasing rate of the supply electric power frequency becomes.

As for the amplitude of supply electric power, the larger the amplitude becomes, the higher requested output the supply electric power becomes able to conform to. However, as the amplitude of supply electric power becomes larger, inductance loss in the alternating-current wiring routes 7 may be increased and may result in decreased energy transmitting efficiency. Therefore, the calculation of the amplitude of supply electric power will be made in accordance with a map of requested output−supply electric power amplitude shown in FIG. 4C. In this map, correlation of requested output−supply electric power amplitude is set such that the higher the requested output becomes, the gradually smaller the increasing rate of the supply electric power amplitude becomes. The maps shown in FIG. 4B and FIG. 4C are those determined based on results confirmed by experiments previously made on the effects of the aforementioned skin effect and inductance loss. Once the operation of S104 is complete, the process proceeds to S105.

In S105, an alternating-current output from the battery unit 60 is controlled based on the result of calculation made in S104. Here, a state of charge (SOC) of the battery 2 is taken into consideration. Specifically, if the SOC of the battery 2 is equal to or less than 50%, there may be no output (discharge) from the battery 2, but rather, the battery 2 may take in (charge) a part of electric power generated in the fuel cell 1. On the other hand, if the SOC of the battery 2 is greater than 50%, there may be discharge from the battery 2. The amount of discharge of this time is determined by the aforementioned requested output and the SOC of the battery 2. Once the operation of S105 is complete, the process proceeds to S106.

In S106, a requested-to-generate output for the fuel cell 1 is calculated. This requested-to-generate output is an output that the fuel cell 1 is requested to generate in running of the vehicle 10, and more specifically, is represented by a sum of the aforementioned requested output, an auxiliary output that is necessary to drive auxiliaries not shown in FIG. 1 required to drive the fuel cell 1, and a for-battery output according to the SOC of the battery 2. Since the battery 2 either discharges or charges based on the SOC as described above, the output of the fuel cell 1 will decrease by just that much if the battery 2 discharges and in contrast, will increase by just that much if the battery 2 charges. This change of output of the fuel cell 1 according to the SOC of the battery 2 is thus taken into consideration as the for-battery output. Once the operation of S106 is complete, the process proceeds to S107.

In S107, electric power is generated in the fuel cell 1 in an attempt to achieve the requested-to-generate output that was calculated in S106. Specifically, amount of hydrogen supply from the hydrogen tank 5 and amount of air supply to the fuel cell 1 are controlled. Once the operation of S107 is complete, the process proceeds to S108.

In S108, an generable output in the fuel cell 1 is calculated. This generable output is an output that the fuel cell 1 can actually generate at this point in time. That is, although electric power is generated in an attempt to achieve the requested-to-generate output in S107, the output as requested may sometime be not achieved right away due to some delay in supply of air and the like to the fuel cell 1. Therefore, the generable output is calculated in order to check for any difference between this requested-to-generate output and the actually available output. Specifically, this generable output is calculated based on supply flow of air and the like to the fuel cell 1. Once the operation of S108 is complete, the process proceeds to S109.

In S109, a generate command output to the fuel cell 1 is calculated as the least value among aforementioned requested-to-generate output and the generable output. That is, the actual alternating-current output from the fuel cell unit 50 is determined as this generate command output, and will then be received by the fuel cell inverter 3 from the ECU 20. Once the operation of S109 is complete, the process proceeds to S110.

In S110, phase difference of the alternating-current output from the fuel cell unit 50 with respect to the alternating-current output from the battery unit 60, the output of which having been controlled in S105, is determined such that the generate command output that was calculated in S109 can be achieved, and in response to this phase difference, the fuel cell inverter 3 is controlled. Actual distribution of electric power between the electric power supplied from the fuel cell 1 to the motor 9 and the electric power supplied from the battery 2 to the motor 9 is determined by the phase difference between the alternating-current output from the fuel cell unit 50 and the alternating-current output from the battery unit 60. That is, the more the phase of the alternating-current output from the fuel cell unit 50 is advanced from the phase of alternating-current output from the battery unit 60, the more the electric power is distributed from the fuel cell 1. Thus, the ECU 20 stores relationship between the aforementioned phase difference and the generate command output in a form of map in advance, compares the map and the generate command output that was calculated in S109, and thereby determines to what extent the phase of the alternating-current output from the fuel cell unit 50 should be advanced. And, based on that determined phase difference, a command is issued from the ECU 20 to the fuel cell inverter 3. Once the operation of S110 is complete, the process proceeds to S111.

In S111, a motor-usable output, which indicates how much output the motor 9 can use at a maximum when supplied with electric power, is calculated. Specifically, the motor-usable output is represented as a sum of the generate command output that was calculated in S109 and an available battery output i.e. a maximum output to be supplied from the battery 2. Note that the available battery output is calculated in consideration of parameters relating to the output of the battery 2, such as SOC, temperature, and the like of the battery 2. Once the operation of S111 is complete, the process proceeds to S112.

In S112, a motor-drive command output is calculated as the least value among the requested output that was calculated in S103 and the motor-usable output that was calculated in S111. That is, the motor-drive command output is calculated as an output that the motor 9 should exert or is capable of exerting actually. Once the operation of S112 is complete, the process proceeds to S113.

In S113, frequency and amplitude of alternating-current power to be actually supplied to the motor, that is, of alternating-current power to be actually supplied from the matrix converter 8 to the motor 9, are determined based on the number of revolutions per minute of the motor 9 and the motor-drive command output calculated in S112, and according to these determined values, the matrix converter 8 is controlled in S114. This enables the motor 9 to achieve the necessary output by using supply of electric power received from the fuel cell 1 and the battery 2 as alternating-current power source devices.

### Second Embodiment

Now described is another embodiment of the electric power supply control shown in FIG. 3. In the above embodiment, the phase difference of the alternating-current output from the fuel cell unit 50 with respect to the alternating-current output from the battery unit 60 was controlled in order to determine the distribution of electric power from the fuel cell 1. In the present embodiment, however, the phase difference is set to zero, thereby making the output from the fuel cell 1 zero. In this way, only the alternating-current output from the battery unit 60, the output of which having been controlled in S105, will be allowed to be supplied to the motor 9, and thus, generation of electric power in the fuel cell 1 can be stopped.

This control of phase difference is conducted by the ECU 20 with respect to the fuel cell inverter 3, when generation of electric power in the fuel cell 1 is to be stopped and the vehicle 10 is to be driven only by energy charged in the battery 2.

### INDUSTRIAL APPLICABILITY

As above, according to an electric power supply system according to the present invention, which supplies electric power from a plurality of direct-current power source devices to an alternating-current drive apparatus, it is possible to keep electrical insulation between electric power supply wirings and a moving body with relative ease as well as make connection between the direct-current power source devices in a simple and easy way.

1. An electric power supply system mounted on a moving body, the electric power supply system supplying electric power from a plurality of direct-current power source devices to an alternating-current drive apparatus that functions as a drive source of the moving body, wherein:
each of the plurality of direct-current power source devices is connected to a corresponding inverter that converts a direct-current output of the direct-current power source device into an alternating-current output, and the each of the direct-current power source devices and the corresponding inverter corresponding thereto forms one alternating-current output unit,
an output of the alternating-current output unit to the outside of the unit is an alternating-current output, and alternating-current wirings are used to make connection between each alternating-current output unit and the alternating-current drive apparatus and between respective alternating-current output units,
the electric power supply system further comprising an alternating-current output control unit that controls frequency and/or amplitude of an alternating-current output from the alternating-current output unit according to a requested electric power from the alternating-current drive apparatus, and
the alternating-current output control unit controls frequency and/or amplitude of the alternating-current output based on surface heat generation and inductance loss in the alternating-current wirings.

2. An electric power supply system mounted on a moving body, the electric power supply system supplying electric power from a plurality of direct-current power source devices to an alternating-current drive apparatus that functions as a drive source of the moving body, wherein:
each of the plurality of direct-current power source devices is connected to a corresponding inverter that converts a direct-current output of the direct-current power source device into an alternating-current output, and the each of the direct-current power source devices and the corresponding inverter corresponding thereto forms one alternating-current output unit,
an output of the alternating-current output unit to the outside of the unit is an alternating-current output, and alternating-current wirings are used to make connection between each alternating-current output unit and the alternating-current drive apparatus and between respective alternating-current output units,
the electric power supply system further comprising an alternating-current output control unit that controls frequency and/or amplitude of an alternating-current output from the alternating-current output unit according to a requested electric power from the alternating-current drive apparatus, and
the alternating-current output control unit controls frequency of the alternating-current output according to a map that sets correlation between requested electric power from the alternating-current drive apparatus and supply electric power frequency to the alternating-current drive apparatus in relation to surface heat generation in the alternating-current wirings.

3. An electric power supply system in accordance with claim 1, wherein one of the plurality of direct-current power source device comprises a reference direct-current power source device, and
the electric power supply system further comprises an alternating-current phase control unit that controls phase difference of an alternating-current output from one alternating-current output unit including the direct-current power source device other than the reference direct-current power source device with respect to an alternating-current output from the reference alternating-current output unit including the reference direct-current power source device.

4. An electric power supply system in accordance with claim 3, wherein the alternating-current phase control unit makes the alternating-current output from the reference alternating-current output unit and the alternating-current output from the one alternating-current output unit have the same phase, thereby setting output electric power from the one alternating-current output unit to zero.

5. An electric power supply system in accordance with claim 1, wherein the electric power supply system has two direct-current power source devices, and
one direct-current power source device is an electric power generating device that outputs direct-current power through generation of electric power, and/or the other direct-current power source device is a storage battery device that has a storage unit and outputs electric power stored by the storage unit as direct-current power.

6. An electric power supply system in accordance with claim 5, wherein the electric power generating device is a fuel cell that generates electric power through electrochemical reaction between hydrogen gas and oxidizing gas and thereby outputs direct-current power.

7. An electric power supply system in accordance with claim 1, further comprising:
a matrix converter having an input of alternating-current output from each of the alternating-current output units and thereby outputting any alternating-current output with respect to the alternating-current drive apparatus.

8. An electric power supply system in accordance with claim 2, wherein one of the plurality of direct-current power source device comprises a reference direct-current power source device, and
the electric power supply system further comprises an alternating-current phase control unit that controls phase difference of an alternating-current output from one alternating-current output unit including the direct-current power source device other than the reference direct-current power source device with respect to an alternating-current output from the reference alternating-current output unit including the reference direct-current power source device.

9. An electric power supply system in accordance with claim 8, wherein the alternating-current phase control unit makes the alternating-current output from the reference alternating-current output unit and the alternating-current output from the one alternating-current output unit have the same phase, thereby setting output electric power from the one alternating-current output unit to zero.

10. An electric power supply system in accordance with claim 2, wherein the electric power supply system has two direct-current power source devices, and
one direct-current power source device is an electric power generating device that outputs direct-current power through generation of electric power, and/or the other direct-current power source device is a storage battery device that has a storage unit and outputs electric power stored by the storage unit as direct-current power.

11. An electric power supply system in accordance with claim 10, wherein the electric power generating device is a fuel cell that generates electric power through electrochemical reaction between hydrogen gas and oxidizing gas and thereby outputs direct-current power.

12. An electric power supply system in accordance with claim 2, further comprising:
a matrix converter having an input of alternating-current output from each of the alternating-current output units and thereby outputting any alternating-current output with respect to the alternating-current drive apparatus.
